(19) United States
(12) Patent Application Publication
(10) Pub. No.: US 2008/0305012 A1
(43) Pub. Date: Dec. 11, 2008

(54) Method and Device For Checking Whether a Liquid Transfer Has Been Successful

(76) Inventor: Hans Camenisch, Chur (CH)

Correspondence Address: NOTARO AND MICHALOS, 100 DUTCH HILL ROAD, SUITE 110, ORANGEBURG, NY, 10962-2100, US

(21) Appl. No.: 12/158,152

(22) PCT Filed: Dec. 11, 2006
(86) PCT No.: PCT/EP2006/069508

§ 371 Date: Jul. 18, 2008

(30) Foreign Application Priority Data
Dec. 21, 2005 (CH) 02027/05
Jun. 9, 2006 (CH) 00939/06

(51) Int. Cl. B01L 3/02

(52) U.S. Cl. 422/100

(57) ABSTRACT

The invention relates to a method for checking whether the transfer of liquid samples has been successful. In said method, a pipetting system or a dispensing system is made to transfer a liquid sample (1) at a specific location (2), and it is verified whether said liquid sample (1) has actually been transferred. The inventive method is characterized in that a distribution image (4) of the intensity of the heat radiation released by said specific location (2) is recorded once the liquid sample (1) has been transferred. Said method can be used in a pipetting system or a dispensing system by making such systems dispense or accept a liquid sample (1) and then checking whether said liquid sample (1) has actually reached or been accepted at the specific location (2). According to the invention, this is achieved by the fact that a distribution image (4) of the intensity at least of the inherent heat radiation released by the specific location (2) is recorded by means of an infrared camera (12) once the liquid sample (1) has been transferred and is compared to a distribution image (4′) of the intensity of the heat radiation of said location (2) or the surroundings (5) thereof, which is recorded before the liquid sample (1) is dispensed or accepted.

This patent application claims priority of the Swiss patent applications No. CH 02027/05 of Dec. 21, 2005 and CH 00939/06 of Jun. 9, 2006 as well as of the international application PCT/EP2006/069508 of Dec. 11, 2006. The entire content of all these applications is incorporated herein by explicit reference and for any purpose.

The invention relates to a method according to the preamble of the independent claim 1 for execution verification upon liquid transfer when pipetting or dispensing liquid samples, in which a pipetting system is caused to aspirate or dispense and/or a dispensing system is caused to dispense a liquid sample to a specific location and it is subsequently established whether this liquid sample has actually been aspirated or dispensed at this specific location.

The necessity for an execution verification of this type is known in the technology of liquid handling in many laboratories. Industrial branches which are concerned with pharmaceutical research and/or clinical diagnostics using biochemical techniques, for example, require facilities for processing liquid volumes and liquid samples. Automated facilities typically comprise a single pipetting or dispensing device and/or multiple such devices, which are located on the worktable of a workstation. Such workstations are often capable of executing greatly varying work on these liquid samples, such as optical measurements, pipetting, washing, centrifuging, incubation, and filtration. One or more robots, which operate according to Cartesian or polar coordinates, may be used for simple processing at such a workstation. Such robots may carry and reposition liquid containers such as shells, sample tubes, or microplates. Such robots may also be used as a so-called “robotic sample processor”, for example, as a pipetting device for aspirating and dispensing, or as a dispenser for distributing liquid samples. Such facilities are preferably monitored and controlled by a computer. A decisive advantage of such facilities is that large numbers of liquid samples may be processed automatically over long periods of times of hours and days without a human operator having to engage in the processing process.

Liquid samples are classically dispensed on slides or in containers. Such slides may also have, in addition to a plurality of materials, a plurality of sizes, shapes, and surface structures. Thus, microplates having depressions, the so-called “wells” are suitable in particular as trough-shaped slides for liquid samples or samples comprising a liquid. Greatly varying devices already exist for the automated handling of such microplates, which are also known as Microtitration® plates (trademark of Thermo Electron Corporation).

The type of treatment or assay of the samples also has an influence on the design and the material of the slide. Glass slides have thus been used traditionally for light microscopy and/or slides made of single-crystal silicon have been used for scanning electron microscopy or slides made of pyrolytic graphite for scanning-tunneling microscopy. The use of carriers made of plastic (e.g., polycarbonate, polystyrene, or polyolefins) is also known. The use of plates which have a flat or also a structured surface on which biological and organic molecules are immobilized as so-called “biochips” is known from the biosciences. Metal plates as slides are often used for “MALDI TOF-MS”, “Matrix Assisted Laser Desorption Ionization—Time of Flight Mass Spectrometry”.

Especially in clinical diagnostics, the operational security and reliability of the transfer of liquid samples is extremely important, so that misdiagnoses may be at least technically precluded. The current liquid handling instruments or systems have reached a very high standard in regard to processing quality, usage reliability, and operating precision. Nonetheless, technical errors which may not be attributed to the instruments per se and are caused by poorly defined or even faulty samples, for example, may not be entirely precluded.

With this background of processing large sample numbers and the possibly fatal consequences of a misdiagnosis, an independent verification of a successfully run liquid aspiration or liquid dispensation for all pipetting or dispensing robots appears highly desirable.

Up to this point, dispensing verifications for liquid samples have been known as so-called “liquid dispense check” (LDC) or as an actual “liquid arrival check” (LAC). Users of LDC instruments concentrate on the actual pipetting or dispensing process and are satisfied that a liquid sample has actually been dispensed. For this purpose, for example, light barriers and or pressure or flow sensors are installed in the systems dispensing liquid samples. If, for example, no liquid was dispensed, erroneously, this may be indicated to the user so that the procedure may be repeated or the experiment may be discarded. Although LDC instruments offer additional reliability, they may not guarantee that a liquid transfer was actually successful, i.e., that the liquid sample has actually arrived at the intended location or has been received therein. If the judgment relates to the actual receipt of a liquid volume, the corresponding verification may also be referred to as LAC, but with the meaning “liquid aspirate check” here.

The single LAC known up to this point is based on the coupling of ultrasonic waves into the floor of a microplate to be monitored. The analysis of the received echo results in the liquid volume in each well of this microplate, so that incorrect fillings may be discovered. This technology is comparatively costly and makes a pipetting system significantly more expensive, for example. In addition, this ultrasonic technology contains several further disadvantages, such as the fact that the devices required for this purpose are bulky and require complicated installation, and the microplates must be moistened to couple the ultrasonic signals onto their floor.

From the document WO 99/34206 A1, a method for combinatorial material development using differential thermal images is known. The reaction kinetics of chemical or physical processes on materials of combinatorial libraries is reported to produce a thermal tinge which is visualized by recording thermal difference images with an infrared (IR) camera. The kinetics of a library of 9 reactions has been observed simultaneously in different wells of a microplate (cf. example 2). Kinetics were observed only after initial defining a temperature calibrating “zero line” by recording two IR images of a container with a reaction mixture at +5° C. or −5° C., respectively. The actual reaction kinetics was then recorded at a defined temperature of 30° C. by taking a series of several IR images after having dispensed a volume of a catalyst into the container.

From the document US 2005/0014247 A1, a method and machine for ex situ production of low and medium integrated biochip networks is known. Sample micro droplets that are dispensed to surfaces of substrates are disclosed. For checking whether such a micro droplet effectively has arrived at an intended location, a display system with a mirror and a camera is located below the substrate, which is penetrated by appropriate illumination with visible light or IR light.

From the document EP 0 493 857 A2, an improved method for detecting pre-spotting of a substrate by micro droplets of samples during the process of dispensing a sample volume onto the substrate is known. An infrared (IR) light emitting diode is utilized to produce irradiation of the substrate and a photo sensitive transistor or photo diode is utilized to record the IR light that penetrates the substrate and sample droplets as well.

From the document WO 2004/099937 A2, a microarray dispensing system with real-time verification and inspection is known. The real-time verification and inspection comprises at least one light source for illumination of a receiving surface as well as at least one camera operating in conjunction with the at least one light source for acquiring and transmitting surface image date to a computer.

The present invention is therefore based on the object of suggesting an alternative method for the execution verification upon liquid transfer during pipetting or dispensing of liquid samples, using which, after a pipetting system or a dispensing system is caused to aspirate or dispense a liquid sample at a specific location, it may be established whether this liquid sample actually reached this specific location or has been aspirated there.

This object is achieved according to a first aspect in that a method for execution verification upon transfer of liquid samples is suggested. This method comprises the steps of:
(a) initiating an aspiration or a dispense of a liquid sample at a specific location; and
(b) utilizing an infrared camera for recording a distribution image of the intensity of the inherent thermal radiation emitted at least by this specific location following to an expected execution of the liquid sample transfer initiated in step (a),
wherein the execution verification method further comprises the steps of:
(c) comparing the intensities of the inherent thermal radiation emitted from this specific location and an environment located adjacent to this specific location, the comparison being based on the distribution image recorded in step (b);
(d) relating the intensities compared in step (c) to the expected aspiration or dispense of a liquid sample; and
(e) deciding about whether the liquid sample has actually been transferred or not.
   This object is achieved according to a second aspect in that a device is suggested for performing this verification method. The device comprises a pipetting system or a dispensing system for the transfer of a liquid sample at a specific location and an infrared camera for recording a distribution image of the intensity of the inherent thermal radiation at the specific location and its environment following to an expected execution of the liquid sample transfer initiated in step (a), the device being accomplished to be connectable to a computer or to comprise such a computer for carrying out image processing,
wherein the device in connection with the calculating system is capable of:
(c) comparing the intensities of the inherent thermal radiation of at least the specific location and an environment located adjacent to this specific location, the comparison being based on the distribution image recorded in step (b);
(d) relating the intensities compared in step (c) to the expected aspiration or dispense of a liquid sample; and
(e) deciding about whether the liquid sample has actually been transferred or not.

The device preferably comprises an endoscope optically connected to an infrared camera for recording a distribution image of the intensity of at least the thermal radia-tion given off by this specific location after completed aspiration or dispensing of this liquid sample.

Additional preferred features according to the invention and a corresponding system for dispensing liquid samples result from the dependent claims.

Advantages of the method according to the invention and/or the device according to the invention comprise:
improved resolution in comparison with methods which are based on the ultra-sound reflection of the microplate surface;
a relatively cost-effective device in comparison with devices which are based on confocal microscopy or Raman spectroscopy;
a time-saving method in comparison to weighing methods, which weigh each individual volume addition;
a clear ability to assign the aspirated or dispensed liquid volumes to specific wells of a microplate is provided, even if these microplates comprise 96, 384, 1536, or more wells;
the independence in relation to the type, volume, color, material, and shape of the container (in particular if the container (e.g. the well) or the slide (e.g., a glass slide) comprises thermally insulating material);
the independence from liquid handling effects, such as different meniscal shapes, foam, or air bubbles;
the verification is performed without any contact of the liquids, so that no so-called carryover is a concern;
incorrect manipulations may be recognized online and corrected immediately;
the recognition of bubbles or foam on the surfaces of liquid samples, by which false detection of this surface may be avoided during liquid level detection (LLD);
the dispensed volume may be ascertained by computer;
it may be decided on the basis of the distribution image of the intensity of at least the thermal radiation given off by a specific location whether the dispensing or aspiration of a liquid sample was successful.

The method according to the invention is explained in detail on the basis of schematic drawings of exemplary embodiments which do not restrict the scope of the invention. In the figures:

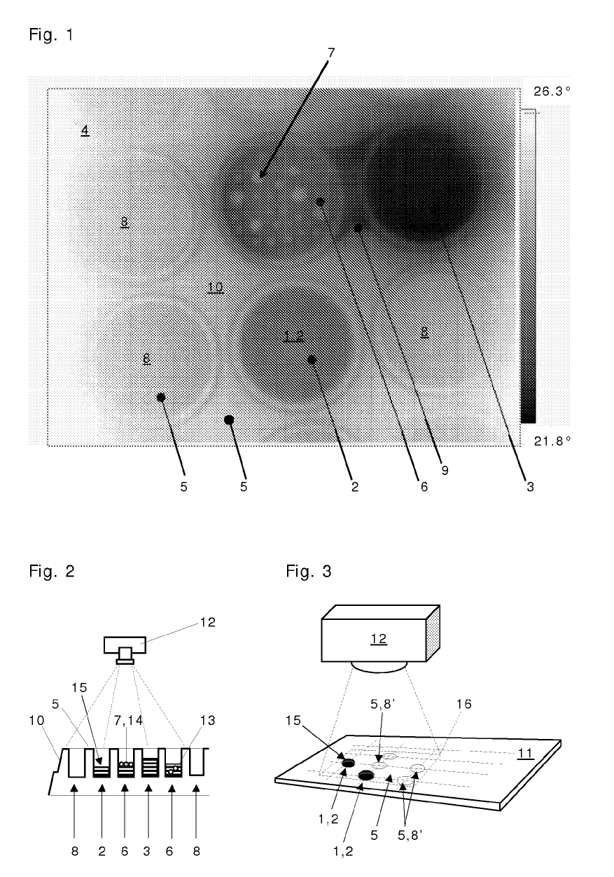

FIG. 1 shows an infrared recording of a microplate having multiple wells which are filled differently with water;

FIG. 2 shows a vertical section through a device for performing the method according to the invention, which comprises an infrared camera, a microplate being used as a vessel;

FIG. 3 shows a 3-D view of a glass slide having liquid samples;

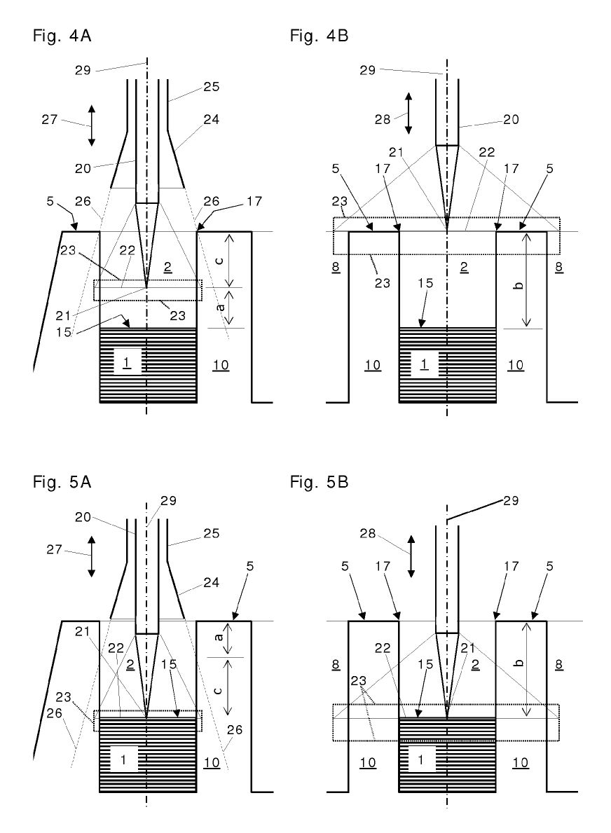

FIG. 4 shows a vertical section through a device for performing the method according to the invention on a microplate, the device comprising an endoscope which is optically connected to an infrared camera, and:

FIG. 4A showing a combination of endoscope with fiber optics upon detection of the upper well edge using the fiber op-tics, and

FIG. 4B showing an endoscope having a wide-angle objective upon detection of the upper well edge using the endoscope;

FIG. 5 shows a vertical section through a device for performing the method according to the invention on a microplate, the device comprising an endoscope which is optically connected to an infrared camera, and:

FIG. 5A showing a combination of the endoscope with fiber optics upon detection of the liquid surface using the endoscope, and

FIG. 5B shows an endoscope having a wide-angle objective upon detection of the liquid surface using the endoscope.

FIG. 1 shows an experimental infrared recording of a microplate having multiple wells which are filled differently with water. The detected temperature range from 21.8° C. (dark) to 26.3° C. (light) is plotted in a scale. This infrared recording is based on the distribution of the thermal radiation registered using the camera, which originates from the photographed object. An infrared camera 12 of the type Thermo Vision™ A40-M from FLIR Systems, which was equipped with autofocusing, was used. This camera may compile differences in the thermal radiation intensity at a resolution up to 0.08° C. in distribution images. The thermal radiation was captured on a digital photo sensor. The raw data of the image was subjected to filtering and digitally stored.

A well was defined in this experiment as a “specific location 2”, at which a 150 μl sample 1 of mineral water containing carbonic acid was dispensed. This properly filled well 2 filled is shown darker on the distribution image 4 of the thermal radiation emitted by the microplate 10 than the empty adjacent well 8 of the same microplate 10. The thermal radiation given off above this well 2 is thus less than that of its environment 5.

A 300 μl sample of the same liquid was dispensed in another well 3. This well 3 appears even darker than the first well 2 having 150 μl filling. The thermal radiation given off by this well 3 is thus less than that of the well 2 or its dry environment 5.

A 150 ml sample which was mixed with soap foam was dispensed in a further well 6. This well 6 appears to emit approximately an equal amount of heat as the well 2; however, the soap bubbles 7 are visible as lighter (warmer) points in this well 6. A splash 9 is visible on the surface of the microplate 10 between the two wells 3 and 6. The measured thermal radiation of this splash 9 approximately corresponds to that of the well 3.

One possible explanation of the differing intensity of the thermal radiation is, for example, that a specific thermal radiation originates from the microplate 10, which is a function of its material and its temperature, which is preferably in equilibrium before the dispensing of samples. The dispensed water apparently has a somewhat lower temperature than the microplate 10, which is kept at room temperature, and obstructs heat emitted from the microplate due to its layer thickness. This would explain why the darkest points (cooler) are shown where the thickest water layer is located (in well 3). Because the air-filled soap bubbles 7 displace the water, the areas of the soap bubbles appear as light (warm) spots 7, which are visible due to the penetration of the heat emitted from the microplate 10. The intensity of the emitted heat of the microplate in the filled wells may, due to evaporation of the water on the surface 15 of the liquid, additionally also be reduced by the consumption of evaporation heat, i.e., by additional cooling of the water.

The differing intensity of the thermal radiation may also arise solely due to the evaporation heat which is withdrawn by the evaporation of the liquid of a volume in proximity to its surface 15. If one starts from a thermal equilibrium of the sample carrier (e.g., microplate 10 or slide 11) and a sample 1 of a liquid is pipetted onto the sample carrier, it begins to evaporate immediately. The larger the liquid surface 15, the greater the evaporation rate of this liquid. The heat required for evaporation withdraws a volume in proximity to its surface 15 from the liquid. This heat withdrawal causes cooling, so that the intensity of the thermal radiation correspondingly decreases at the liquid surface 15—the liquid appears darker on the infrared image. If the temperature of the pipetted liquid is initially below the temperature of the sample carrier or vessel, it appears even darker in relation to the vessel. If one exclusively measures the surface temperature of a liquid sample 1 using the infrared camera 12 and if this liquid sample is pipetted at a temperature slightly increased or slightly decreased in relation to the container or sample carrier, for example, the effective volume of the liquid sample may be concluded by computer from the temperature curve established using a photo series.

However, a superposition of the effects just described may occur depending on the combination of container or carrier materials and liquid samples, the proportions of the individual effects additionally being able to vary.

Although the contrast resulting in this infrared recording is not explained in all details by the interpretations just given (Why do the external, vertical surfaces of the empty adjacent well 8 appear cooler than the surface of the microplate 10 and the floor of this well, for example? Why are the floors of the empty wells 8 shown darker (cooler) than the surface of the microplate 10? Why does the contrast of the external, vertical surfaces of the wells not appear to be influenced by the different filling of the wells?), it is still clear from this experiment that unambiguous statements may be made about the arrival of a liquid sample in a specific container (a well of a microplate 10 here) using recording of a distribution image 4 of the thermal radiation given off from this specific location using an infrared camera 12. The extent to which additional measures such as providing a thermostat-controlled environment free of draft (e.g., in the form of a pipetting chamber) are necessary is the subject matter of future studies.

The method according to the invention is preferably refined in that the distribution image 4 of the thermal radiation intensity recorded for this specific location 2 is compared to a distribution image 4′ of the intensity of the thermal radiation at this location 2 recorded before the dispensing of this liquid sample 1. For this purpose, a system for performing this method may be equipped with a digital memory for providing comparison images. However, a first infrared recording may also be prepared before the dispensing and the second infrared recording may be prepared after the dispensing. These two reality images may then be compared directly.

Alternatively to the method discussed up to this point, it may be provided that one distribution image 4 of the intensity of the thermal radiation given off by this specific location 2 and its environment 5 is recorded and the intensity of the thermal radiation at the specific location 2 is compared to the intensity of the thermal radiation of its environment 5.

The contrast in the distribution images to be achieved of the radiated heat may also be additionally increased in that directly before or during the recording of the distribution image 4 of the intensity of the thermal radiation at least given off by this specific location 2, a brief thermal irradiation of at least this specific location 2 is performed (e.g., in the form of one or more flashes). The background radiation of a microplate 10 is thus elevated in relation to that at room temperature, so that a liquid kept at room temperature and released into the wells appears cooler (darker). Depending on the liquid and the material of the vessel, the liquid may also appear lighter (warmer).

Depending on the material of the vessels used and in accordance with the dispensed liquid, another intensity distribution may also arise; it is important in any case that the thermal radiation of the vessels may be established using the infrared camera 12 as an intensity difference from the thermal radiation which the liquid emits. This intensity difference may be amplified by temperature control (cooling or heating) of the container or by a brief infrared irradiation before establishing the intensity distribution using the IR camera 12. A defined unstable or stable thermal imbalance is thus provided. A defined thermal imbalance is often easier to generate than a stable thermal equilibrium, in that a temperature-controlled receptacle is provided for heating or cooling for at least one slide 11 or at least one microplate 10. The thermal transition between the temperature-controlled receptacle and the slide or the microplate must allow an actual heat flow between the receptacle and the sample.

The location at which the dispensing of a liquid volume is to be verified is not restricted to wells of a microplate 10. The verification method is also suitable for flat or structured slides 11 made of glass or other materials or for other containers, such as sample tubes, troughs, and the like. The defined container may thus be selected from a group which comprises a well of a microplate, a trough, a cuvette, and a tube.

In addition, a selected position 2 may lie on a flat surface of a slide 11, on a raised surface, or on a depressed surface of this slide or object carrier (cf. FIG. 3). The environment 5 may be defined in such a manner that it is a selected adjacent position on the slide 11, or it is the slide 11 itself. In addition, the environment 5 may be a defined adjacent container 8 or the microplate 10. The selected adjacent position 8′ on the slide 11 (cf. FIG. 3) or the defined adjacent container 8 (cf. FIG. 2) may also have an already dispensed liquid sample 1. The comparison thus does not always have to be executed with a dry surface or with an empty container.

FIG. 2 shows a vertical section through a device for performing the method according to the invention, which comprises an infrared camera 12. A microplate 10 or its wells are used as the vessel. The infrared camera 12 may be provided with an objective and situated at a distance to the microplate 10 in such a manner that only one well or a few wells (cf. FIG. 1) are imaged. By changing the focal width and/or distance of the objective from the microplate, however, an entire microplate 10 or even multiple microplates may be imaged jointly. According to FIG. 1, a well is also provided with a reference numeral 2 here, which is both filled correctly and is also located at a location intended for it. This well has a liquid sample 1. Another well 3 is provided with a larger liquid volume. This may have been deliberate or may also be a result of a malfunction of the liquid handling device. Further wells 6 are provided with liquid samples which have either soap bubbles 7 or soap foam 14 on their surface, or which have gas bubbles in the interior of the liquid sample 1. In contrast, neither the surface 15 nor the interior of the liquid sample 1 has bubbles or foam in the correctly filled well 2. Empty adjacent wells 8 are also shown next to it. In the cases in which the entire microplate may not be photographed in a single recording, the microplate 10 and infrared camera 12 are implemented as movable in relation to one another. The microplate 10 is preferably received on a mechanical stage known from microscopy, for example, so that the entire microplate may be scanned. However, the camera may also be moved appropriately.

It is advantageous if the focus varies when recording the distribution image 4 of the thermal radiation intensity at this location 2 and the liquid surface 15 and the environment 5 are thus imaged sharply, so that the focused recordings of the thermal radiation intensity at this location 2 and its environment 5 may be combined with one another using image processing. Using image processing methods known per se, the level of the liquid surface 15 or the liquid volume in a well of a microplate 10 may be determined using the combination of the focused recordings of the thermal radiation intensity at this location 2 and its environment 5.

FIG. 3 shows a 3-D view of a glass slide having liquid samples on its surface. The device for performing the method according to the invention also comprises an infrared camera 12 here. A glass slide 11 having a smooth surface, as is known from light microscopy, is used as the vessel or as the sample carrier. The infrared camera 12 may be provided with an objective and situated at a distance to the slide 11 in such a manner that only a part of the slide (the dashed area 16 here), the entire slide, or even multiple such slides 11 may be imaged. The simultaneous imaging of microplates 10 and slides 11 is also conceivable. Two positions on the slide are provided with a reference numeral 2. These indicate that a liquid sample 1 was properly dispensed at a location intended for this purpose in each case. Adjacent positions 8′ are also shown next to them, which are included in the environment 5 here and do not have liquid samples. In the cases in which the entire slide 11 may not be photographed in a single recording, the slide 11 and the infrared camera 12 are implemented as movable in relation to one another. The slide 11 is preferably received on a mechanical stage known from microscopy, for example, so that the entire slide may be scanned. However, the camera may also be moved appropriately.

It is advantageous if the focus varies during the recording of the distribution image 4 of the thermal radiation intensity at this location 2 and the liquid surface 15 and the environment 5 are thus imaged sharply, so that the focused recordings of the thermal radiation intensity at this location 2 and its environment 5 may be combined with one another using image processing. As already shown in the experiment (cf. FIG. 1), the presence of gas bubbles 13 in the liquid sample 1 or foam 14 on the liquid surface 15 may be verified using the combination of the focused recordings of the thermal radiation intensity at this location 2 and its environment 5. The verification of gas bubbles in a liquid sample or foam on the surface of a liquid may be used for the decision as to whether or not samples are to be taken from this container. The focal width of the infrared camera 12 kept at a constant distance is preferably varied using an autofocus function to vary the focus when recording the distribution image 4 of the thermal radiation intensity at this location 2. The height difference of the sharply imaged liquid surface 15 to its sharply imaged environment 5 may thus be ascertained on the basis of the resulting focal width change.

Alternatively, it is preferable, for varying the focus when recording the distribution image 4 of the thermal radiation intensity at this location 2, for the focal width of the infrared camera 12 to be kept constant, the distance of the camera to the liquid sample surface 15 to vary, and the height difference of the sharply imaged liquid surface 15 to its sharply imaged environment 5 to be ascertained on the basis of this distance change.

The present invention additionally comprises a device for performing the method for the execution verification of liquid dispensing when pipetting or dispensing liquid samples, which comprises a pipetting system or a dispensing system for dispensing a liquid sample 1 at a specific location 2. This device is characterized in that it comprises an infrared camera 12 for recording a distribution image 4 of the intensity of at least the thermal radiation emitted by this specific location 2 after the dispensing of this liquid sample 1.

Such a device according to the invention is preferably connectable to a computer for executing greatly varying image processing methods or comprises such a computer.

This computer is preferably capable of analyzing the focal width change and/or analyzing the distance change.

A system for dispensing liquid samples which comprises a work table for positioning slides and/or containers, a robot for pipetting or dispensing a liquid sample 1 at a specific location 2 in relation to these slides and/or containers, and a computer for controlling this robot is especially preferable. This system is characterized in that it additionally comprises a device according to the invention for performing the method for the execution verification of liquid dispensing upon pipetting or dispensing of liquid samples.

Systems which comprise a dark chamber having a temperature-controlled receptacle for at least one slide 11 or at least one microplate 10 may be used at practically arbitrary locations and at least essentially independently of the current room temperature.

In connection with the present invention, the following definitions apply for the determination of liquid volumes:
A liquid sample is a specific volume of a liquid. This includes a droplet in the sub-microliter range, drops in the sub-milliliter range, or also volumes of multiple milliliters.
A container is any device which may receive liquid volumes therein. This includes one or more wells of a microplate 10 or microtitration plate, troughs; tubes having very small volumes, so-called micro-tubes, cuvettes, etc.

The surface of a slide 11 may be flat like the surface of a glass object carrier known per se for light microscopy or a MALDI target, for example. The slide 11 may also have any type of relief structures, e.g., for dividing areas, however. These may be grooves and other depressions and/or fins and other protrusions. In addition, slides may also comprise levels at different heights for this purpose.

Distribution images of the thermal radiation intensity recorded after the dispensing of a liquid sample using an infrared camera may be recorded from above at high sensitivity (cf. FIGS. 2 and 3). In these cases, the infrared camera is thus above the slide or container for the samples. Alternatively thereto, the thermal radiation intensity may be recorded from below; the infrared camera is positioned below the slide or container for the samples for this purpose. This alternative position of the infrared camera has the advantage that the camera may be installed fixed in the work platform. In addition, the optics may be housed in a closed space; contamination of the lenses is thus prevented and the reproducibility of the measurement results is improved. In both alternative camera configurations, optical fibers may be used for practically glare-free acquisition of the thermal radiation intensity at specific points.

FIG. 4 shows a vertical section through a device for performing the method according to the invention on a microplate 10, the device comprising an endoscope 20, which is optically connected to an infrared camera (not shown). FIG. 4A shows, in a first embodiment of the device having endoscope, a combination of the endoscope 20 with fiber optics 24 while detecting the well edge 17 using the fiber optics 24. Using its optics, the endoscope on its optical axis 29 defines a focal point 21, which lies in the center of the observation area in the focal plane 22. The observation area is also referred to as an area having sufficient depth of field for observation or as a depth of field area 23. It is generally known that approximately ⅓ of this area having sufficient depth of field lies in front of the focal point viewed from the observer and approximately ⅔ of this area lies behind the focal point viewed from the observer; this was taken into consideration when drawing the depth of field area 23 indicated by dashed lines. In addition, it is known that optics having a small observation angle and longer focal width have a smaller depth of field area than optics having a larger observation angle and shorter focal width. For example, an objective was selected here for the endoscope 20 which has an observation angle and a corresponding image plane or focal plane 22, which is just sufficient to image the entire cross-section of a 96-well microplate.

The fiber optics 24 comprises a bundle of optical fibers 25 which are implemented on one hand to emit illumination beams and on the other hand to detect the reflected light in an opposite observation direction. This is achieved in that approximately half of the optical fibers are connected to a light source, and the remainder of the optical fibers is connected to a camera. This fiber optics is preferably operated using visible light. The optical fibers 25 are situated, separated according to function, essentially alternately around the endoscope 20 and essentially parallel thereto. In the area of the endoscope end, the optical fibers 24 are situated flared out in such a manner that the emitted light beams result in an annular illumination, the diameter of this illumination increasing with increasing distance to the endoscope end. Depending on the number and caliber of the optical fibers used, the illumination ring may also be composed of an annular configuration of discrete points of light. The flared area of the optical fibers 25 preferably has a diameter which is less than the diameter of the well 2 to be studied. It is thus ensured that the endoscope/fiber optics combination may plunge into a well 2 if needed. The opening angle α of the fiber optics 24 is preferably constant and known.

If the upper well edge 17 is to be detected using the fiber optics 24, the microplate 10 and the endoscope/fiber optics combination are moved in relation to one another in the essentially horizontal X and/or Y directions until the optical axis 29 penetrates the desired well 2. This movement is preferably controlled and/or regulated using a computer and executed by a robot (not shown). This procedure may be monitored using the fiber-optic camera. Subsequently, the endoscope/fiber optics combination is lowered using the robot and the illumination ring generated using the fiber optics, which continuously becomes smaller, is observed using the fiber-optic camera. An eventual eccentricity of the optical axis 29 in the well 2 to be recorded may be established and the mutual position of microplate 10 and endoscope/fiber optics combination may be corrected. At the instant at which the illumination ring plunges into the well 2, it may be observed that the diameter of the illumination ring remains constant. This transition marks a specific Z position of the endoscope/fiber optics combination, which has just been reached in FIG. 4A. Upon assuming this Z position, a current distance of the image plane 22 to the upper well edge 17 results—corresponding to the opening angle α of the fiber optics and corresponding to the geometric configuration and optical design of the fiber optics in combination with the currently used microplate type. This current distance is constant if the endoscope/fiber optics combination and microplate type are always identical and is identified in FIG. 4A by the value c.

FIG. 5A shows a vertical section corresponding to FIG. 4A. The endoscope/fiber optics combination has been lowered here by the Z travel path having the value a until the image plane 22 is just coincident with the liquid surface 15 of the previously dispensed sample 1. On the basis of this Z movement path a and the constant c, the volume of the sample 1 in the well 2 may be calculated using a known total volume given by the microplate type. It is noticeable that in the embodiment shown in FIGS. 4A and 5A, the points of light of the illumination ring of the fiber optics lie outside the image plane of the endoscope 20. However, the image plane 22 preferably has an extent large enough that it is penetrated by the illumination ring of the fiber optics (not shown). In this preferred embodiment, a fiber-optic camera may be dispensed with if the infrared camera of the endoscope is capable of recording the visible light of the illumination ring of the fiber optics 24. The illumination ring may also be generated using infrared light, however, so that the infrared camera may then record this directly.

FIG. 4B shows, in a second embodiment of the device, an endoscope 20 upon detection of the well edge 17. The endoscope 20 defines a focal point 21, which lies in the center of the observation area in the focal plane 22, using its optics on its optical axis 29. The observation area is also referred to as an area having sufficient depth of field for observation or as a depth of field area 23 (cf. also FIG. 4A). However, this endoscope 20 is not equipped with fiber optics. In contrast, this endoscope 20 has a wide-angle objective having a larger observation angle, so that the image plane 22 may image the well 2 and the upper edge 17 of the walls enclosing this well 2. If the upper well edge 17 is to be detected using the endoscope 20, the microplate 10 and endoscope 20 are moved in relation to one another in the essentially horizontal X and/or Y directions until the optical axis 29 penetrates the desired well 2. This movement is preferably controlled and/or regulated using a computer and executed by a robot (not shown). This procedure may be monitored using the endoscope camera. The endoscope 20 is subsequently lowered using the robot and the surface of the microplate is observed using the endoscope camera. An eventual eccentricity of the optical axis 29 in the well 2 to be recorded may be established and the mutual position of microplate 10 and endoscope 20 may be corrected. The instant at which the upper well edge 17 of the well 2 corresponds to the image plane or focal plane 22, i.e., this upper well edge 17 is in focus, has just been reached in FIG. 4B.

A vertical section corresponding to FIG. 4B is shown in FIG. 5B. The endoscope 20 has been lowered by the Z travel path or height travel path having the value b until the image plane 22 is just coincident with the liquid surface 15 of the previously dispensed sample 1. The volume of the sample 1 in the well 2 may be calculated using a known total volume given by the microplate type on the basis of this Z travel path b. The level of the liquid surface 15 is thus determined using a combination of the focused recordings of the thermal radiation intensity at this location 2 and its environment 5 and the liquid volume in a well 2 of a microplate 10 is determined from the height travel path. Visible light or infrared light may be coupled into the endoscope to illuminate the microplate 10, or this microplate may additionally be illuminated from above and/or below.

Fundamentally, optical fibers, such as glass fibers and the like may be used to supply the infrared emission distribution image acquired by optics to an infrared camera. This infrared camera may therefore be installed at practically arbitrary locations and—protected from influences from the laboratory environment and/or the work platform of the liquid handling workstation if necessary—in a system for dispensing or aspirating liquid samples.

### REFERENCE NUMERALS

1 liquid sample
2 specific location, correctly filled well
3 other well
4 current distribution image
4′ archived distribution image for comparison
5 environment
6 further well
7 soap bubbles
8 adjacent well, adjacent container
8′ adjacent position
9 splash
10 microplate
11 slide
12 infrared camera
13 gas bubbles
14 foam
15 liquid surface
16 photographed partial area of the slide
17 upper well edge
20 endoscope
21 focal point of the endoscope
22 focal plane of the endoscope
23 depth of field area of the endoscope
24 fiber optics
25 optical fibers
26 illumination beams and observation direction of the fiber optics
27 Z movement direction of the endoscope/fiber optics combination
28 Z movement direction of the endoscope
29 optical axis
a height travel path or Z travel path of the combination device
b height travel path or Z travel path of the endoscope
c constant height difference for a specific microplate type and for a specific endoscope/fiber optics combination

1-25. (canceled)

26. Method for the execution verification upon transfer of liquid samples, the method comprising the steps of:
(a) initiating an aspiration or a dispense of a liquid sample at a specific location; and
(b) utilizing an infrared camera for recording a distribution image of the intensity of the inherent thermal radiation emitted at least by this specific location following to an expected execution of the liquid sample transfer initiated in step (a), wherein the execution verification method further comprises the steps of:
(c) comparing the intensities of the inherent thermal radiation emitted from this specific location and an environment located adjacent to this specific location, the comparison being based on the distribution image recorded in step (b);
(d) relating the intensities compared in step (c) to the expected aspiration or dispense of a liquid sample; and
(e) deciding about whether the liquid sample has actually been transferred or not.

27. The execution verification method of claim 26, wherein a pipetting system or a dispensing system is caused to dispense a liquid sample, and subsequently, checking whether the liquid sample has actually been transferred to this specific location is carried out.

28. The execution verification method of claim 26, wherein a pipetting system is caused to aspirate a liquid sample at a specific location, and subsequently, checking whether the liquid sample has actually been aspirated from this specific location is carried out.

29. The execution verification method of claim 26, wherein the intensities compared in step (c) are related to the volume of the transferred liquid sample.

30. The execution verification method of claim 26, wherein, immediately prior to recording the distribution image of the intensity of the inherent thermal radiation of at last the specific location and an environment, a brief thermal irradiation is directed to the specific location and the environment.

31. The execution verification method of claim 26, wherein, the environment is selected from a group that comprises at least one adjacent container, a surface of a microplate, and a surface of a slide.

32. The execution verification method of claim 31, wherein, the adjacent container already contains a dispensed liquid sample.

33. The execution verification method of claim 31, wherein, a liquid sample has already been removed from the adjacent container.

34. The execution verification method of claim 26, wherein, the specific location is located inside a defined container or on an slide.

35. The execution verification method of claim 34, wherein, the defined container is selected from a group that comprises a well of a microplate, a trough, a cuvette, and a sample tube.

36. The execution verification method of claim 26, wherein, for recording the distribution image of the intensity of the inherent thermal radiation according to step (b), the focus is set to the level of the liquid surface of the liquid sample, and wherein a second distribution image of the intensity of the inherent thermal radiation is recorded, in which the environment is in focus, whereupon the two distribution images of the intensity of the inherent thermal radiation at the specific location and its environment are combined by image processing methods.

37. The execution verification method of claim 36, wherein, through combination of the focused images of the distribution image of the intensity of the inherent thermal radiation at the specific location and its environment, the level of the liquid sample is determined inside a well of a microplate.

38. The execution verification method of claim 36, wherein, through combination of the focused images of the distribution image of the intensity of the inherent thermal radiation at the specific location and its environment, the presence of gas bubbles in the liquid sample or the presence of foam at the surface of the liquid sample is detected.

39. The execution verification method of claim 36, wherein, between the recordings of the two distribution images of the intensity of the inherent thermal radiation at the specific location and its environment, the focal length of the infrared camera is varied by auto focus function while the infrared camera is kept in constant distance, and wherein the level difference of the focused liquid level surface to the focused environment is determined on the basis of the resulting focal length difference.

40. The execution verification method of claim 36, wherein, between the recordings of the two distribution images of the intensity of the inherent thermal radiation at the specific location and its environment, the focal length of the infrared camera is kept constant while the distance of the infrared camera to the liquid level surface of the liquid sample is varied, and wherein the level difference of the focused liquid level surface to the focused environment is determined on the basis of the resulting distance difference.

41. The execution verification method of claim 40, wherein, for varying the distance of an objective of the infrared camera to the liquid level surface of the liquid sample, the objective is optically connected to an endoscope.

42. A device for carrying out the liquid transfer execution verification method of claim 36, the device comprising a pipetting system or a dispensing system for the transfer of a liquid sample at a specific location and an infrared camera for recording a distribution image of the intensity of the inherent thermal radiation at the specific location and its environment following to an expected execution of the liquid sample transfer initiated in step (a), the device being accomplished to be connectable to a computer or to comprise such a computer for carrying out image processing.

43. The device of claim 42, wherein, the device comprises an endoscope, which is optically connected to the infrared camera for recording the distribution image of the intensity of the inherent thermal radiation.

44. A system for transferring liquid samples, the system comprising a work table for positioning of slides and/or containers, a robot for pipetting or dispensing of a liquid sample at a specific location with respect to these slides and/or containers, and a computer for controlling the robot, wherein the system further comprises a device according to claim 42.

45. The system of claim 44, wherein the system comprises a darkroom with a temperature controlled support for at least one slide or at least one microplate.
